(19) United States
(12) Patent Application Publication
(10) Pub. No.: US 2021/0328217 A1
(43) Pub. Date: Oct. 21, 2021

(54) LITHIUM BATTERY AND ANODE MATERIAL THEREOF

(71) Applicant: National Tsing Hua University, Hsinchu City (TW)

(72) Inventors: Tsung-Yi Chen, Hsinchu City (TW); Syuan-Yu Wang, Hsinchu City (TW); Chun-Han Kuo, Hsinchu City (TW); Han-Yi Chen, Hsinchu City (TW)

(73) Assignee: National Tsing Hua University, Hsinchu City (TW)

(21) Appl. No.: 16/914,449

(22) Filed: Jun. 28, 2020

(30) Foreign Application Priority Data
Apr. 21, 2020 (TW) 109113256

(51) Int. Cl. H01M 4/525; H01M 4/505; H01M 4/133; H01M 4/131; H01M 4/134; H01M 4/62; H01M 10/0525; H01M 2/16

(52) U.S. Cl. CPC H01M 4/525; H01M 4/505; H01M 4/133; H01M 2/1673; H01M 4/134; H01M 4/623; H01M 10/0525; H01M 4/131

(57) ABSTRACT

A lithium battery and an anode material thereof are provided. The anode material for a lithium battery includes a spinel-structured high entropy oxide represented by (NiₐMn_{b}Fe_{c}M1_{d}M2ₑ)₃O₄, where M1 and M2 are independently selected from Co, Ti, Sn, Si, Al, Cu, Zn, Mg, Ca, Mo, Ru, Zr, or Nb, a+b+c+d+e=1, 0.01<a<0.35, 0.01<b<0.35, 0.01<c<0.35, 0.01<d<0.35, and 0.01<e<0.35.

### CROSS-REFERENCE TO RELATED APPLICATION

This application claims the priority benefit of Taiwan application no. 109113256, filed on Apr. 21, 2020. The entirety of the above-mentioned patent application is hereby incorporated by reference herein and made a part of this specification.

### BACKGROUND

### Technical Field

The disclosure relates to a lithium battery technique, and particularly to a lithium battery and an anode material thereof.

### Description of Related Art

With the advantages of high energy density, high operating voltage, low self-discharge rate, and long storage life, the lithium battery has become a much researched battery system in recent years and has been widely used in portable electronic application products.

The anode materials commonly used in lithium batteries today are mainly graphite-based carbon materials and non-graphite-based carbon materials, which exhibit high structural regularity and stability and thus excellent cycle stability. However, each mole of graphite (C₆) can only be embedded with one mole of lithium ions, so the theoretical capacity is only about 372 mA h g⁻¹, which limits the development of high energy density lithium ion batteries.

The non-graphite-based anode materials developed in recent years include silicon and metal alloys. The theoretical capacity of silicon is extremely high, and it is currently an anode material with much potential. However, a significant volume change (approximately 300%) occurs in the charging and discharging process, which results in a rapid decline in the capacity. Moreover, the diffusion coefficient of lithium ions in silicon is low, which limits the actual application of silicon.

Among the metal alloy-based anode material, tin (Sn) is more commonly used, and the capacity of tin metal can be as high as 800 mA h g⁻¹. However, when lithium is embedded in the tin anode, it will be in the Li₂O network structure, resulting in a large number of irreversible reactions of tin oxide in the electrochemical reduction process.

### SUMMARY

The disclosure provides an anode material for a lithium battery, which increases the capacity while improving the issue of material disintegration.

The disclosure also provides a lithium battery, which has a long battery life without a large number of irreversible reactions, and has a high cycle number.

A anode material for a lithium battery of the disclosure includes a spinel-structured high entropy oxide represented by (NiₐMn_{b}Fe_{c}M1_{d}M2ₑ)₃O₄, where M1 and M2 are independently selected from Co, Ti, Sn, Si, Al, Cu, Zn, Mg, Ca, Mo, Ru, Zr, or Nb, a+b+c+d+e=1, 0.01<a<0.35, 0.01<b<0.35, 0.01<c<0.35, 0.01<d<0.35, and 0.01<e<0.35.

In an embodiment of the disclosure, ratios of metal elements of the spinel-structured high entropy oxide per 750 μm³ volume are the same.

In an embodiment of the disclosure, M1 and M2 are independently selected from Co or

Ti, for example.

In an embodiment of the disclosure, the spinel-structured high entropy oxide comprises (Ni_{0.2}Co_{0.2}Mn_{0.2}Fe_{0.2}Ti_{0.2})₃O₄ or (Ni_{0.2}Co_{0.2}Mn_{0.2}Fe_{0.2}Sn_{0.2})₃O₄.

In an embodiment of the disclosure, the anode material for a lithium battery may further include a conductive agent, and based on a total weight of the anode material for a lithium battery, a content of the conductive agent is 30 wt % or less.

In an embodiment of the disclosure, the conductive agent includes graphite, carbon black, carbon fiber, carbon nanotube, acetylene black, mesocarbon microbead (MCMB), graphene, or a combination thereof.

In an embodiment of the disclosure, the anode material for a lithium battery may further include a binder, and based on a total weight of the anode material for a lithium battery, a content of the binder is 20 wt % or less.

In an embodiment of the disclosure, the binder includes styrene-butadiene rubber latex (SBR), carboxymethyl cellulose (CMC), polyvinylidene difluoride (PVDF), polyimide, acrylic resin, butyral resin, polytetrafluoroethylene latex (PTFE), polyacrylate (PAA), or a combination thereof.

A lithium battery of the disclosure includes a cathode, an anode, a separator, and an electrolyte. The anode is made from the above anode material for a lithium battery. The separator is located between the cathode and the anode.

In another embodiment of the disclosure, a material of the cathode includes lithium metal, lithium cobaltate (LiCoO₂), lithium manganate (LiMn₂O₄), lithium iron phosphate (LiFePO₄), lithium nickelate (LiNiO₂), lithium cobalt nickel oxide (LiCoNi_{1-X}O₂, X<1), or lithium nickel cobalt manganese aluminum oxide (LiNi_{1-x-y}CoₓN_{y}O₂, N is Mn and Al, x+y<1).

Based on the above, the disclosure adopts specific spinel-structured high entropy oxides as the anode material for a lithium battery, which can increase the capacity to approximately 560 mA h g⁻¹, can improve the shortcoming of large irreversible reactions, and has a high cycle number. Thereby, the performance of the lithium battery can be significantly improved.

To make the aforementioned more comprehensible, several embodiments accompanied with drawings are described in detail as follows.

### BRIEF DESCRIPTION OF THE DRAWINGS

FIG. 1 is a schematic view showing a lithium battery according to an embodiment of the disclosure.

FIG. 2 is an XRD diffraction diagram of a sample of Experimental Example 1.

FIG. 3A shows an SEM image of the sample of Experimental Example 1.

FIG. 3B shows an EDS mapping image of Mn element in the sample of Experimental Example 1.

FIG. 3C shows an EDS mapping image of Ni element in the sample of Experimental Example 1.

FIG. 3D shows an EDS mapping image of Ti element in the sample of Experimental Example 1.

FIG. 3E shows an EDS mapping image of Fe element in the sample of Experimental Example 1.

FIG. 3F shows an EDS mapping image of Co element in the sample of Experimental Example 1.

FIG. 4 is an XRD diffraction diagram of a sample of Experimental Example 2.

FIG. 5A shows galvanostatic charge and discharge curve of a lithium battery of Experimental Example 1 at a current density of 100 mA h g⁻¹.

FIG. 5B shows the cycle stability and coulombic efficiency of the lithium battery of Experimental Example 1 at a current density of 100 mA h g⁻¹.

FIG. 6 shows charge-discharge curves of the sample of Experimental Example 1.

FIG. 7A shows a transmission X-ray microscopic image of the anode material before cycling.

FIG. 7B shows a transmission X-ray microscopic image of the anode material at 0.01 V.

FIG. 7C shows a transmission X-ray microscopic image of the anode material at 2 V.

FIG. 8A shows galvanostatic charge and discharge curve of a lithium battery of Experimental Example 2 at a current density of 50 mA h

FIG. 8B shows the cycle stability and coulombic efficiency of the lithium battery of Experimental Example 2 at a current density of 50 mA h

### DESCRIPTION OF THE EMBODIMENTS

An anode material for a lithium battery according to an embodiment of the disclosure includes a spinel-structured high entropy oxide represented by (NiₐMn_{b}Fe_{c}M1_{d}M2ₑ)₃O₄, where M1 and M2 are independently selected from Co, Ti, Sn, Si, Al, Cu, Zn, Mg, Ca, Mo, Ru, Zr, or Nb, M1 and M2 are different from each other, a+b+c+d+e=1, 0.01<a<0.35, 0.01<b<0.35, 0.01<c<0.35, 0.01<d<0.35, and 0.01<e<0.35. In an embodiment, M1 and M2 are independently selected from Co or Ti. As for the ranges of a, b, c, d, and e, for example, 0.01<a<0.25, 0.01<b<0.25, 0.01<c<0.25, 0.01<d<0.25, and 0.01<e<0.25. In this embodiment, examples of the spinel-structured high entropy oxide may include, but are not limited to, (Ni_{0.2}Co_{0.2}Mn_{0.2}Fe_{0.2}Ti_{0.2})₃O₄ or (Ni_{0.2}CO_{0.2}Mn_{0.2}Fe_{0.2}Sn_{0.2})₃O₄. The spinel-structured high entropy oxide having the specific compositions and contents may be prepared by high-energy ball milling and high-temperature sintering, and the obtained spinel-structured high entropy oxide has even element distributions. For example, the ratios of metal elements per 750 μm³ volume are the same.

In addition, in an embodiment, the anode material for a lithium battery may further include additives such as a conductive agent and a binder.

Examples of the conductive agent may include, but are not limited to, graphite, carbon black, carbon fiber, carbon nanotube, acetylene black, mesocarbon microbead (MCMB), graphene, or a combination thereof. Based on the total weight of the anode material for a lithium battery, the content of the conductive agent is, for example, 30 wt % or less.

Examples of the binder may include, but are not limited to, styrene-butadiene rubber latex (SBR), carboxymethyl cellulose (CMC), polyvinylidene difluoride (PVDF), polyimide, acrylic resin, butyral resin, polytetrafluoroethylene latex (PTFE), polyacrylate (PAA) or a combination thereof. Based on the total weight of the anode material for a lithium battery, the content of the binder is, for example, 20 wt % or less.

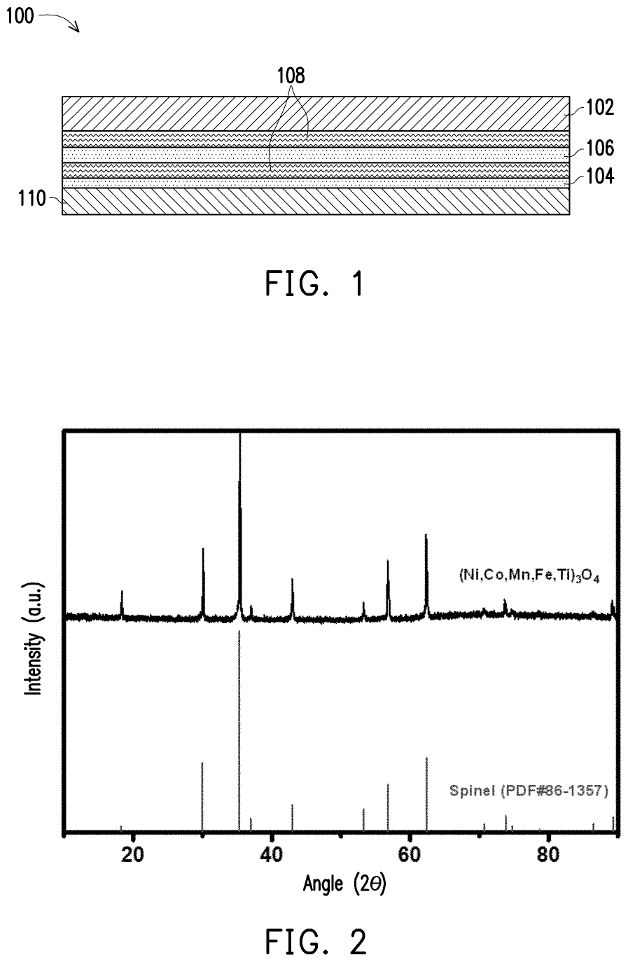

FIG. 1 is a schematic view showing a lithium battery according to another embodiment of the disclosure.

In FIG. 1, a lithium battery 100 includes a cathode 102, an anode 104, a separator 106, and an electrolyte 108. The anode 104 is made from the above anode material for a lithium battery, and the anode 104 generally further includes a metal electrode plate 110 for coating the above anode material for a lithium battery thereon. The separator 106 is disposed between the cathode 102 and the anode 104 to avoid contact between the two electrodes and ensure that ions can be transferred therein. Examples of the separator 106 include, for example, a microporous film, a modified film, a non-woven fabric, or a composite film. In this embodiment, the material of the cathode 102 includes, for example, lithium metal, lithium cobaltate (LiCoO₂), lithium manganate (LiMn₂O₄), lithium iron phosphate (LiFePO₄), lithium nickelate (LiNiO₂), lithium cobalt nickel oxide (LiCoNi_{1-X}O₂, X<1), or lithium nickel cobalt manganese aluminum oxide (LiNi_{1-x-y}CoₓN_{y}O₂, N is Mn and Al, x+y<1). The electrolyte 108 may be a liquid electrolyte, a polymer electrolyte, or a solid electrolyte.

Experiments will be provided below to verify the effect of the disclosure, but the disclosure is not limited thereto.

### Experimental Example 1

First, with Ni:Co:Mn:Fe:Ti at a molar ratio of 1:1:1:1:1, nickel oxide (Ni₂O₃), cobalt oxide (Co₃O₄), manganese oxide (MnO₂), iron oxide (Fe₂O₃), and titanium oxide (TiO₂) were prepared as a precursor (at a total weight of 9 g). After high energy ball milling of the precursor for 1 hour, the mixture was washed and burned until it became a powder. The powder was screened and then dry pressed into a pellet (at a pressure of 12M), which was then sintered at a high temperature for 36 hours (at a sintering temperature of 1350° C.). The sintered pellet was ground into a (Ni_{0.2}Co_{0.2}Mn_{0.2}Fe_{0.2}Ti_{0.2})₃O₄ powder.

### Experimental Example 2

The preparation was the same as that of Experimental Example 1, except that Ti was changed to Sn.

<Structure Analysis>

1. X-ray diffraction analysis (XRD) and Rietveld refinement were performed on the sintered pellet of Experimental Example 1, and the results are as shown in FIG. 2 and Table 1. According to FIG. 2, (Ni,Co,Mn,Fe,Ti)₃O₄ is a single-phase spinel structure (Spinel is the comparative value of the database).

TABLE 1

| | Experimental Example 1 |
|---|---|
| Lattice | Cubic |
| Space group | Fd-3m |
| a (Å) | 8.44 |
| R_{wp} | 9.90 |
| GOF | 1.12 |

According to the result in Table 1, (Ni_{0.2}Co_{0.2}Mn_{0.2}Fe_{0.2}Ti_{0.2})₃O₄ is a spinel structure, and its lattice constant is 8.44 Å.

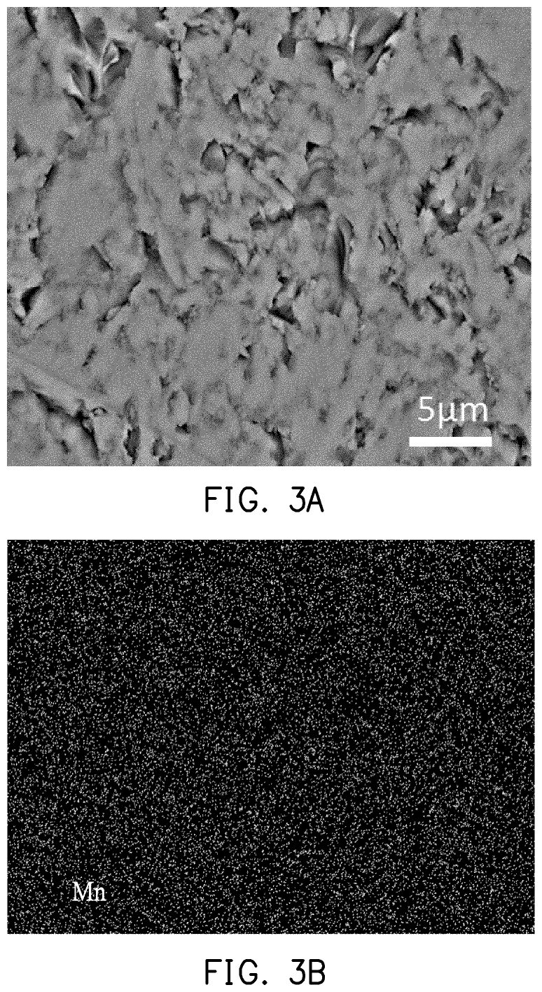

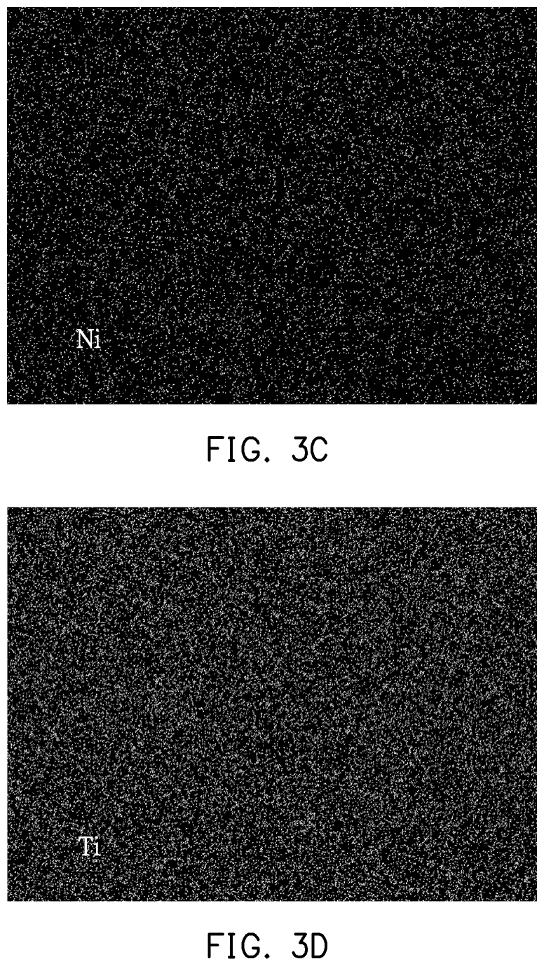

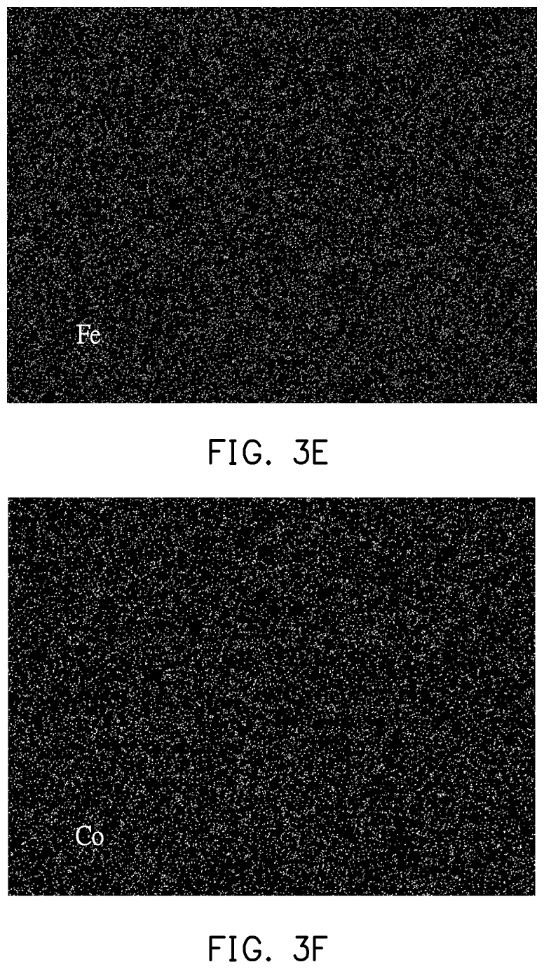

2. EDS elemental analysis was performed on the sample of Experimental Example 1 to obtain the SEM image as in FIG. 3A and the EDS mapping images of the elements Mn, Ni, Ti, Fe, and Co as in FIG. 3B to FIG. 3F. According to FIG. 3A, the measured volume of the sample was at least 750 μm³. According to FIG. 3B to FIG. 3F, the distributions of components Mn, Ni, Ti, Fe, and Co are uniform (i.e., the light-colored dots in the image are uniformly distributed without the formation of precipitates).

3. ICP elemental analysis was performed on the sample of Experimental Example 1, and the result is as shown in Table 2.

TABLE 2

| Element | Ni | Co | Mn | Fe | Ti |
|---|---|---|---|---|---|
| Molar ratio | 1.10 | 1.03 | 1.01 | 0.93 | 1.00 |

According to the result in Table 2, the elements of the sample of Experimental Example 1 are evenly distributed and are at equal ratios, which meets the definition for a high entropy oxide.

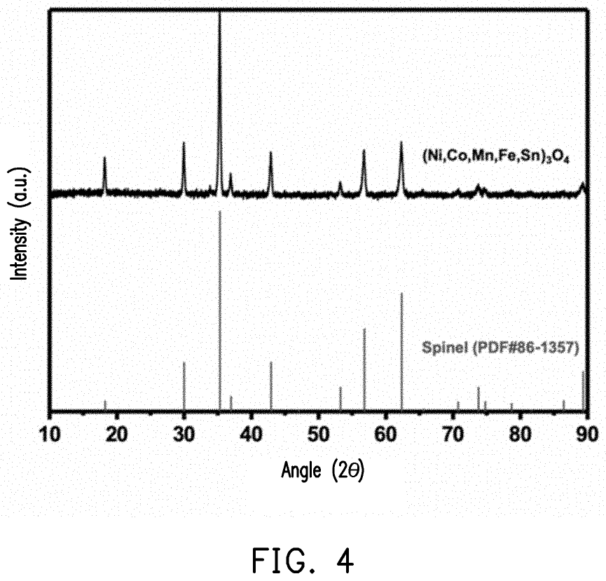

4. XRD analysis was performed on the sintered pellet of Experimental Example 2, and the result is as shown in FIG. 4. According to FIG. 4, (Ni,Co,Mn,Fe,Sn)₃O₄ is also a single-phase spinel structure.

<Fabrication of Lithium Battery>

70 mg of the samples of Experimental Examples 1 and 2 were respectively uniformly mixed with 20 mg of a conductive agent (super P®) and 10 mg of a binder (2.5 wt % CMC and 2.5 wt % SBR dissolved in deionized water) to form a slurry, which was then coated on a copper foil and dried to form an anode.

Next, the anode and an electrolyte separator (Celgard® 2500), a lithium metal sheet together with a steel sheet (serving as the support plate of the lithium metal sheet) were laminated to form a lithium battery.

<Battery Performance Analysis>

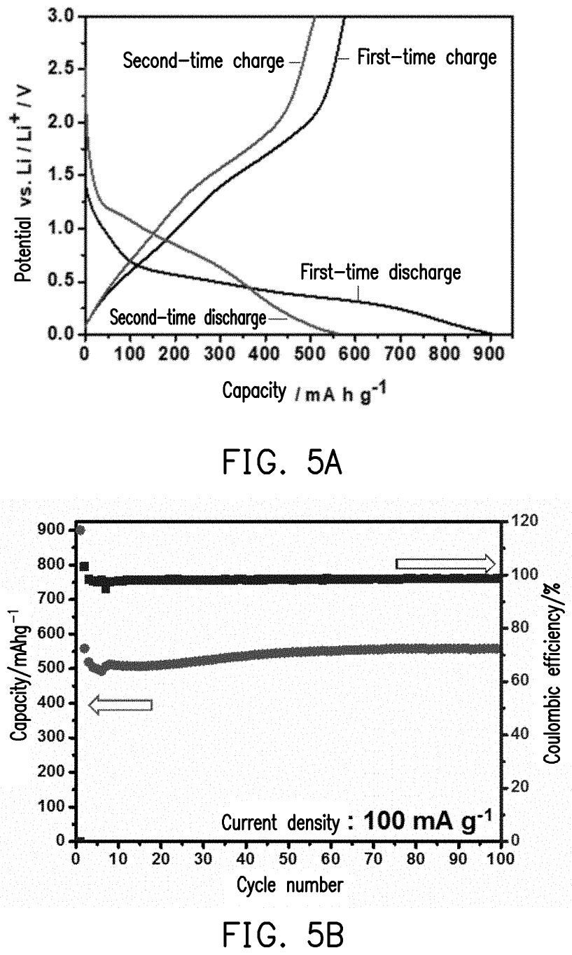

1. The lithium battery containing the anode material of Experimental Example 1 was subjected to electrochemical analysis, and the result is as shown in FIG. 5A and FIG. 5B. FIG. 5A shows constant current charge and discharge curves of the lithium battery at a current density of 100 mA h g⁻¹. FIG. 5B shows the cycle stability and coulombic efficiency of the lithium battery at a current density of 100 mA h g⁻¹.

According to FIG. 5A, the capacities of the first-time and second-time discharges were respectively 900 and 560 mA h g⁻¹, and the first-round irreversible capacity mainly resulted from solid-electrolyte-interface layers decomposed by the electrolyte from the surface of the electrode material and some irreversible conversion reactions. FIG. 5B shows that the coulombic efficiency was close to 100% in 100 charge-discharge cycles with no significant change in the capacity, which means that it had excellent charge-discharge cycle stability.

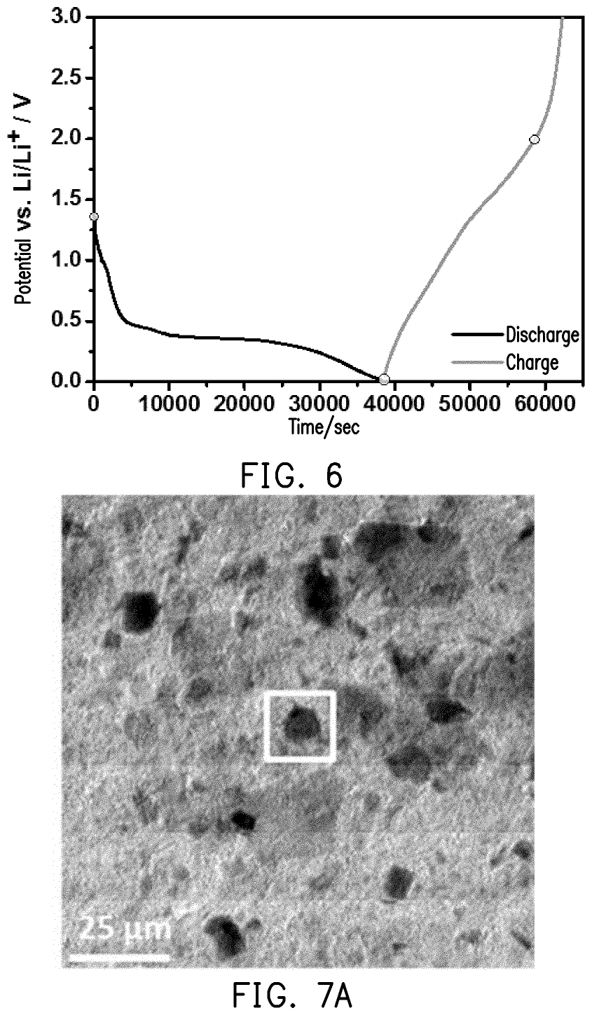

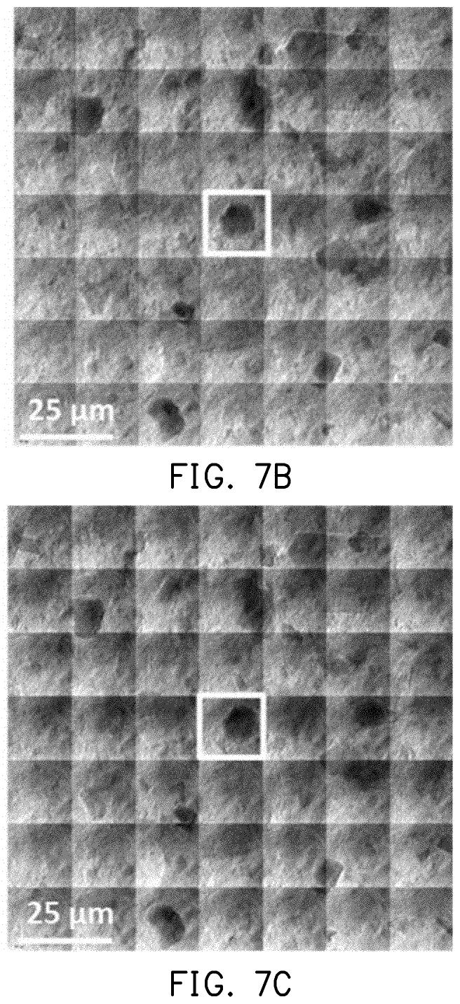

2. An in-situ transmission X-ray microscope of Synchrotron Radiation Center was used to observe whether the anode material containing Experimental Example 1 underwent a significant volume change in the charging and discharging process (as in FIG. 6), and the result is as shown in FIG. 7A to FIG. 7C. FIG. 7A shows a transmission X-ray microscopic image of the anode material before cycling (time is 0 seconds). FIG. 7B shows a transmission X-ray microscopic image of the anode material at 0.01 V. FIG. 7C shows a transmission X-ray microscopic image of the anode material at 2 V.

As shown in FIG. 7B and FIG. 7C, in the charging and discharging process, the volume of the anode material (the portion indicated by the boxes in the figures) did not change significantly as compared to FIG. 7A. Therefore, it is inferred that the high entropy effect can make the structure quite stable, and the tolerable stress is greater, so that the volume does not expand and contract significantly. As a result, the capacity retention rate in the charging and discharging process is excellent.

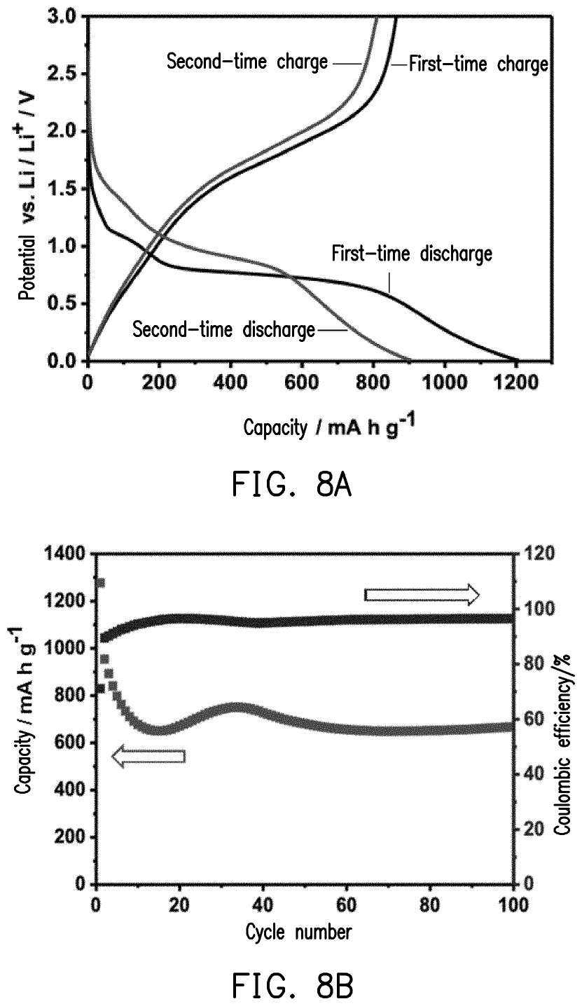

3. The lithium battery containing the anode material of Experimental Example 2 was subjected to electrochemical analysis, and the result is as shown in FIG. 8A and FIG. 8B. FIG. 8A shows galvanostatic charge and discharge curve of the lithium battery at a current density of 50 mA h g⁻¹. FIG. 8B shows the cycle stability and coulombic efficiency of the lithium battery at a current density of 50 mA h g⁻¹.

According to FIG. 8A, the capacities of the first-time and second-time discharges were respectively 1200 and 900 mA h g⁻¹, and the capacity did increase significantly. FIG. 8B shows that the coulombic efficiency is close to 100% in 100 charge-discharge cycles with no significant change in the capacity.

In summary of the above, the disclosure adopts specific five-element spinel-structured oxides as the anode material for a lithium battery, which exhibits excellent capacity, significantly improves the cycle stability, contributes to a longer battery life, and does not lead to a large number of irreversible reactions. Moreover, since the spinel-structured high entropy oxide exhibits high entropy stabilizing effect and can provide high structural stability, when used as the anode material for a lithium battery, they can significantly improve the issue of material disintegration and make the battery more stable.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A anode material for a lithium battery, comprising:
a spinel-structured high entropy oxide represented by (NiₐMn_{b}Fe_{c}M1_{d}M2ₑ)₃O₄, wherein M1 and M2 are independently selected from Co, Ti, Sn, Si, Al, Cu, Zn, Mg, Ca, Mo, Ru, Zr, or Nb, a+b+c+d+e=1, 0.01<a<0.35, 0.01<b<0.35, 0.01<c<0.35, 0.01<d<0.35, and 0.01<e<0.35.

2. The anode material for a lithium battery according to claim 1, wherein ratios of metal elements of the spinel-structured high entropy oxide per 750 μm³ volume are the same.

3. The anode material for a lithium battery according to claim 1, wherein M1 and M2 are independently selected from Co or Ti.

4. The anode material for a lithium battery according to claim 1, wherein the spinel-structured high entropy oxide comprises (Ni_{0.2}Co_{0.2}Mn_{0.2}Fe_{0.2}Ti_{0.2})₃O₄ or (Ni_{0.2}Co_{0.2}Mn_{0.2}Fe_{0.2}Sn_{0.2})₃O₄.

5. The anode material for a lithium battery according to claim 1, further comprising a conductive agent, and based on a total weight of the anode material for a lithium battery, a content of the conductive agent is 30 wt % or less.

6. The anode material for a lithium battery according to claim 5, wherein the conductive agent comprises graphite, carbon black, carbon fiber, carbon nanotube, acetylene black, mesocarbon microbead (MCMB), graphene, or a combination thereof.

7. The anode material for a lithium battery according to claim 1, further comprising a binder, and based on a total weight of the anode material for a lithium battery, a content of the binder is 20 wt % or less.

8. The anode material for a lithium battery according to claim 7, wherein the binder comprises styrene-butadiene rubber latex (SBR), carboxymethyl cellulose (CMC), polyvinylidene difluoride (PVDF), polyimide, acrylic resin, butyral resin, polytetrafluoroethylene latex (PTFE), polyacrylate (PAA), or a combination thereof.

9. A lithium battery comprising:
a cathode;
an anode made from the anode material for a lithium battery according to claim 1;
a separator located between the cathode and the anode; and
an electrolyte.

10. The lithium battery according to claim 9, wherein a material of the cathode comprises lithium metal, lithium cobaltate (LiCoO₂), lithium manganate (LiMn₂O₄), lithium iron phosphate (LiFePO₄), lithium nickelate (LiNiO₂), lithium cobalt nickel oxide (LiCoNi_{1-X}O₂, X<1), or lithium nickel cobalt manganese aluminum oxide (LiNi_{1-x-y}CoₓN_{y}O₂, N is Mn and Al, x+y<1).
